(19) United States
(12) Patent Application Publication
(10) Pub. No.: US 2010/0050435 A1
(43) Pub. Date: Mar. 4, 2010

(54) BLADE TIP REPLACEMENT METHOD

(75) Inventors: Ahmad Zaki Bin Ahmad Zainuddin, Windisch (CH); Matthias Staempfli, Doettingen (CH); Josip Stedul, Untersiggenthal (CH)

Correspondence Address: BUCHANAN, INGERSOLL & ROONEY PC, POST OFFICE BOX 1404, ALEXANDRIA, VA, 22313-1404, US

(73) Assignee: ALSTOM Technology Ltd., Baden (CH)

(21) Appl. No.: 12/203,561

(22) Filed: Sep. 3, 2008

(30) Foreign Application Priority Data
Sep. 2, 2008 (EP) 08163453.7

(51) Int. Cl. B23P 6/00; F01D 5/20

(52) U.S. Cl. 29/889.1; 416/224

(57) ABSTRACT

A gas turbine blade, a gas turbine blade airfoil repair method, and an airfoil corresponding to the product of the method are disclosed. The airfoil extends radially from a platform and includes a tip having a tip edge radially distant from the platform; a trailing edge; and a leading edge. The method includes forming a joining plane extending from the leading edge to the tip edge, wherein the joining plane forms at least one arc; forming a replacement tip fittable on the joining plane; and bonding the replacement tip to the airfoil.

### TECHNICAL FIELD

The disclosure relates to gas turbine blades and gas turbine blade repair methods, including the replacement of turbine blade airfoil tips.

### BACKGROUND INFORMATION

A gas turbine blade of the type made from nickel alloys can be used to operate at high temperature in highly erosive environments. In these environments, the blade airfoil tips can crack or spall due to oxidation, damage by foreign objects in the gas stream or rubbing with the turbine casing. Due to the high cost of the blades it is often desirable to repair them so as to make them suitable for another operational cycle rather than replace them. Where the repair entails bonding of replacement parts, however, the bond, when exposed to operational load, represents a potential point of weakness due to the complexity of welding the advanced blade alloys.

There are several known tip repair methods entailing bonding. For example U.S. Pat. No. 6,908,288 discloses a repair method where a replacement tip is welded onto a straight surface (e.g., plane) made between the leading and trailing edges of an airfoil.

As an alternative DE199 63 714 and FR 2 631 268 disclose repair methods for blade airfoil tips where the radial load is partially borne by the interlocking shape of the airfoil tip interface thus reducing the stress loading and as a result the integrity requirement of the joining weld.

### SUMMARY

A method of forming and fitting a replacement airfoil tip is disclosed that can better withstand centrifugal load while maintaining repair simplicity.

A gas turbine airfoil repair method is disclosed for an airfoil which extends radially from a platform, wherein the airfoil includes a tip edge at an airfoil end radially distant from said platform, a trailing edge and a leading edge, the method comprising: a) forming a joining surface extending from said leading edge to said tip edge, wherein said joining surface forms at least one arc; b) forming a replacement tip fittable on said joining surface; and c) bonding said replacement tip to said airfoil.

A gas turbine airfoil repair method is also disclosed for an airfoil which extends radially from a platform, wherein the airfoil includes: a tip edge at an airfoil end radially distant from said platform, a trailing edge and a leading edge, the method comprising: a) forming a joining surface extending from said leading edge to said tip edge, wherein said joining surface forms an arc towards the tip edge and is angled toward the tip edge; b) forming a replacement tip fittable on said joining surface; and c) bonding said replacement tip to said airfoil.

A gas turbine airfoil repair method is also enclosed for an airfoil connected to a platform wherein the airfoil includes a tip region having a tip edge at an airfoil end distant from said platform, a trailing edge and a leading edge, the method comprising: a) forming a joining surface extending from said leading edge to said tip edge wherein said joining surface forms an arc towards the leading edge; b) forming a replacement tip fittable on said joining surface; and c) bonding said replacement tip to said airfoil.

A gas turbine airfoil is disclosed which extends radially from a platform, the airfoil comprising: a tip edge at an airfoil end configured to be radially distant from the platform and to extend around the airfoil between a trailing edge of the airfoil and a leading edge of the airfoil; a joining surface formed in the airfoil which extends from the leading edge to a portion of the tip edge located between the trailing edge and the leading edge, wherein the joining surface forms at least one arc; and a replacement tip fitted and bounded to the joining surface.

### BRIEF DESCRIPTION OF THE DRAWINGS

Other objectives and advantages of the present disclosure will become apparent from the following description, taken in connection with the accompanying drawings wherein by way of illustration and example, an embodiment of the disclosure is disclosed. By way of example, an embodiment of the disclosure is described more fully hereinafter with reference to the accompanying drawings, in which:

FIG. 1 is a perspective view of a gas turbine blade showing an airfoil with a fitted replacement tip according to an exemplary embodiment of the disclosure;

FIG. 2 is sectional view through II-II of FIG. 1 showing a replacement tip according to an exemplary embodiment of the disclosure;

FIG. 3 is sectional view through II-II of FIG. 1 showing a replacement tip with a tip plate according to another exemplary embodiment of the disclosure;

FIG. 4 is a side view of an exemplary replacement tip of the disclosure wholly incorporating a tip plate;

FIG. 5. is an expanded view of an arc formed in a joining surface according to an exemplary embodiment of the disclosure.

### DETAILED DESCRIPTION

The disclosure is based on the general idea of providing a joining surface (e.g., a joining, or junction plane), onto which a replacement airfoil tip is mounted, extending from a turbine blade's leading edge to a tip edge, wherein the joining surface can include a curve.

One aspect of the disclosure provides a gas turbine airfoil repair method for an airfoil which extends radially from a platform, wherein the airfoil includes a tip having a tip edge radially distant from the platform; a trailing edge; and a leading edge.

Portions of an airfoil which are susceptible to damage include the leading edge and the blade tip, and to minimize the size of the replacement tip, an exemplary method includes:
a) forming a joining surface extending from the leading edge to the tip edge, wherein the joining surface forms at least one arc (e.g., so as to eliminate forming sharp corners where stress can concentrate and lead to premature cracking; sharp corners can be formed, for example, when horizontal and vertical joining planes intersect);
b) forming a replacement tip fittable on the joining surface; and
c) bonding the replacement tip to the airfoil.

An arc in the joining surface not only provides a solution to, for example, the problem of stress concentration, it enables optimum shaping of the replacement tip and increases the ability of the bond to withstand, during operation, centrifugal forces. It does this by, for example, effectively increasing the effective join plane area in the radial direction.

The benefit of a joining surface with arcs can be further realized in another aspect that provides an arc towards the tip edge so that the unnecessary replacement of the trailing edge, which is less susceptible to damage, can be avoided. A yet further aspect provides a joining surface that, towards the leading edge, angles towards the platform end. In this way a larger area of the leading edge, which can be susceptible to damage, can be minimized.

By combining arcs towards both the tip edge and the leading edge in another aspect provides a replacement tip with improved ability to withstand centrifugal forces.

The radii of the arcs can have a material affect on the ease of bonding where the smaller the radius the more difficult it can be to bond by weld, and so the radius can, for example, be greater than 10 mm. If the radius it too large, the benefit of increased weldability can be offset by less than optimum tip replacement size, and so an aspect provides an arc radius of, for example, less than about 20 mm (e.g., substantially between 10 and 20 mm (e.g., approximately between 10 mm+10% or greater and 20 mm±10% or greater)). Other dimensions will be apparent to those skilled in the art and can be determined empirically.

The repair method can be simplified by minimizing the size of the replacement tip, eliminating or at least minimizing any non-functional curvature in the joining surface that does not contribute positively to bond strength. An exemplary, efficient joining surface configuration is one with minimal curvature so as to minimize machining difficulties associated with curve formation, yet with enough curvature to ensure only damaged portions of the tip are replaced. It was found that by locating arcs towards the ends of the joining surface and interspersing the arcs with a straight section or sections, this could be efficiently achieved. An aspect of the disclosure therefore provides arcs that subtend an angle of, for example, substantially, or about between 70°-100° (e.g., approximately 70°±10% or greater and 10°±10% or greater) and in exemplary embodiments, preferably an angle of substantially between 80° to 90°. It was further found to be advantageous to form a straight section between the arc towards the tip edge and, depending on the configuration, the arc towards the leading edge or the leading edge itself. In another aspect at least a part of the straight section may be angled substantially between, for example, 0°-5° (e.g., between about 0°±10% or greater, and 5°±10% or greater) from the tip edge so as to avoid the need for additional joining surface curvature, and the complexities of fabricating such a curve.

In an airfoil configuration where the airfoil includes a tip plate, an aspect of the disclosure further provides a replacement tip with the tip plate wholly formed in the replacement tip.

With reference to the drawings, like reference numerals are used to refer to like elements throughout. In the following description, for purposes of explanation, numerous specific details are set forth in order to provide a thorough understanding of the disclosure. It may be evident, however, that the disclosure may be practiced without these specific details.

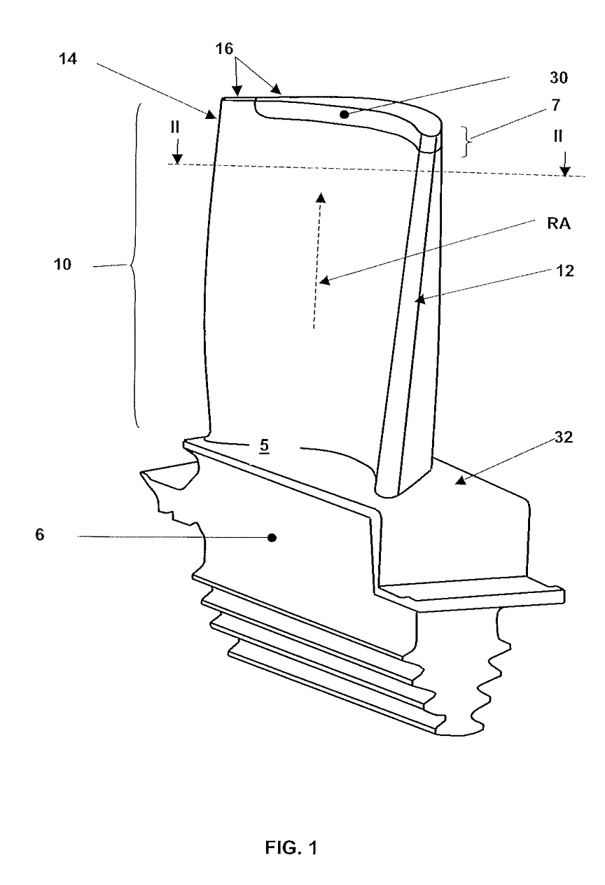

FIGS. 1 to 3 show various exemplary embodiments of an airfoil 10 with a removed end tip portion wherein a joining surface (e.g., join plane) 20 has been formed in the airfoil 10 onto which a preformed replacement tip 30 can be fitted and bonded.

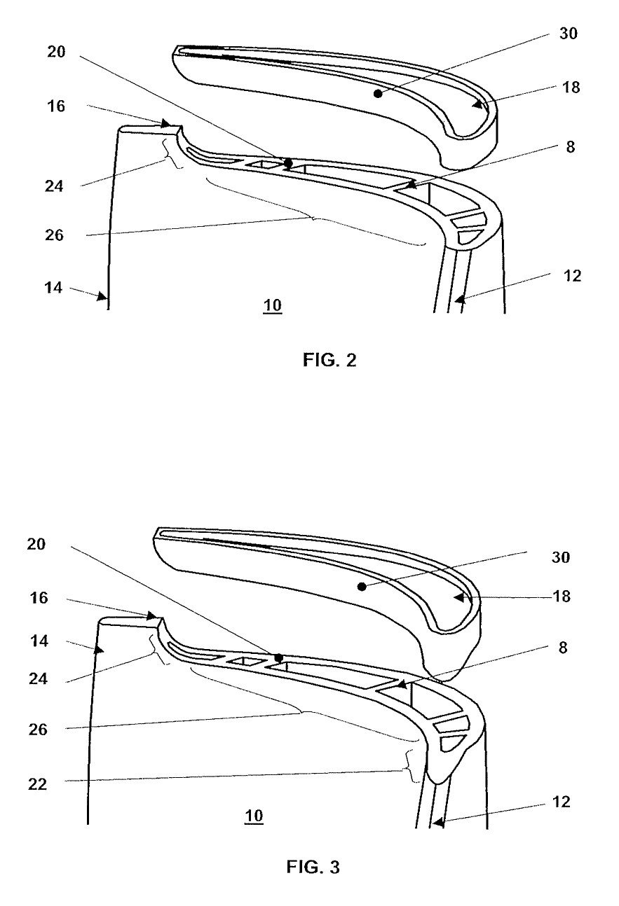

FIG. 1 shows a turbine blade 5 with a fitted replacement tip 30. The tip 30 replaces a portion of the blades airfoil tip region 7 extending from the leading edge 12 of the airfoil 10 to the tip edge 16. In order to ensure that the replacement tip 30 encompasses the regions of the tip 7 that are most susceptible to damage, the joining surface 20 at the interface between the airfoil 10 and replacement tip 30 forms an arc 24 (FIG. 2) towards the tip edge 16. A plane formed by the tip edge 16 defines the tip edge 16, which can be proximately parallel to at least a portion of joining surface 20.

Thus, FIG. 1 shows a gas turbine airfoil which extends radially from a platform, the airfoil comprising a tip edge at an airfoil end configured to be radially distant from the platform and to extend around the airfoil between a trailing edge of the airfoil and a leading edge of the airfoil; a joining surface formed in the airfoil which extends from the leading edge to a portion of the tip edge located between the trailing edge and the leading edge, wherein the joining surface forms at least one arc; and a replacement tip fitted and bonded to the joining surface.

FIG. 2 shows an exemplary embodiment with an airfoil 10 in which a portion of the airfoil's tip 7 between the leading edge 12 and tip edge 16 has been removed. The removed portion forms a joining surface 20 for accepting a replacement tip 30. The contours in the joining surface 20, taking the form of arcs and straight sections, are mirrored in the replacement tip 30 and provide fittability at the joining surface 20 of the prepared airfoil 10 and replacement tip 30. In the exemplified embodiment these contours include an arc 24 which is located towards the tip edge 16 of the airfoil 10 either by ending at the tip edge 16 or alternatively being located proximal to the tip edge 16 by having a short straight section interspaced between the arc 24 and tip edge 16. Alternatively multiple arcs 24 with interspaced straight sections can also be formed.

A straight section 26 in the joining surface 20, as shown in FIG. 2, joins the arc 24 and leading edge 12. This straight section 26 may be parallel to the tip edge 16 or angled, for example, substantially (e.g., approximately, ±10% or greater) between 0° to 5° relative to (e.g., away from) it. Alternatively the straight section 26 may comprise portions that are parallel and other portions that are angled between, for example, substantially 0° to 5° from the tip edge 16, or of other suitable shape.

In another embodiment, as shown in FIG. 3, the joining surface 20 includes an arc 22 towards the leading edge 12 either by ending at the leading edge 12, as exemplified, or alternatively being located proximal to the leading edge 12 by having a short straight portion interspaced between the arc 22 and the leading edge. The arc 22 at the leading edge 12 as shown in FIG. 3 angles towards the FIG. 1 blade platform 6 so as to increase the area at the leading edge 12 of the replacement tip 30. The arc 22 could however also angle towards the tip edge 16. A straight section 26 in the joining surface 20 may also be formed, as shown in FIG. 3, between the arc 24 located towards the tip edge 16 and the arc 22 located towards the leading edge 12. This straight section 26 may be parallel to the tip edge 16 of the blades platform or angled, for example, substantially (e.g., approximately, +10% or greater) between 0° to 5° relative to (e.g., away from) the parallel tip edge 16. Alternatively the straight section 26 may comprise portions that are parallel and other portions that are angled substantially (e.g., approximately, ±10% or greater) between, for example, 0° to 5° relative to the tip edge 16, or be of other suitable shape.

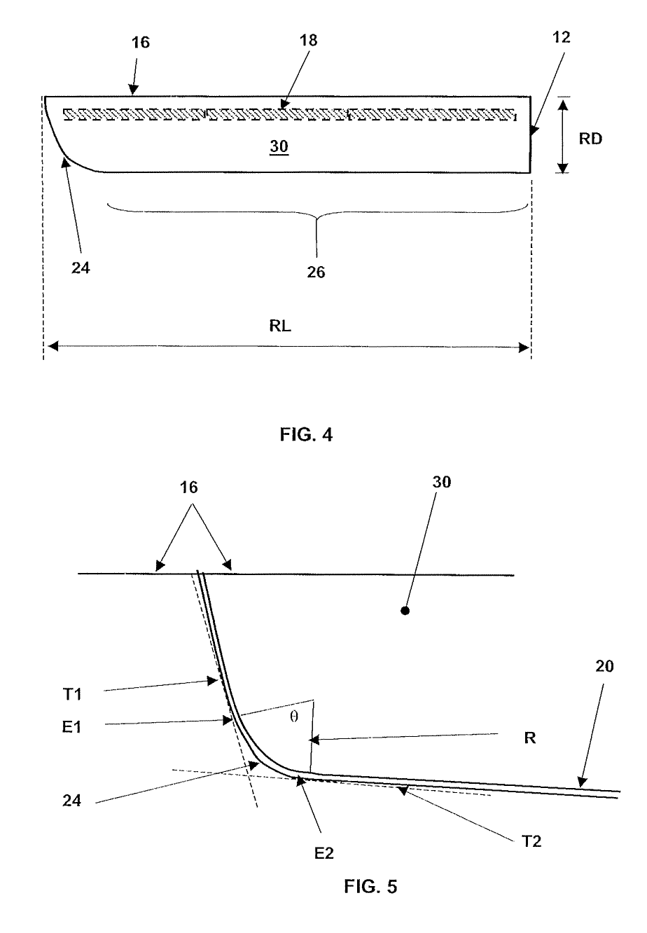

In another embodiment of the disclosure, shown in FIG. 4, where the airfoil 10 includes a tip plate 18 comprising a single plate or alternatively a combination of multiple plates, the tip plate 18 is fully incorporated in the replacement tip 30. This is achieved by, for example, the combination of the depth and length of the replacement tip 30. The depth of the replacement tip RD is the maximum radial depth of the replacement tip and is in part defined by the location and the angle subtended by the arc 24 towards the tip edge 16, and the length RL of the replacement tip is defined as the distance between the point at which the joining surface 20 meets the tip edge 16 and the leading edge. In the embodiment shown in FIG. 4, the point at which the joining surface 20 meets the tip edge 16 is between the trailing edge 14 of the airfoil 10 and the furthest point of extension of the tip plate 18 towards the trailing edge 14. FIG. 4 also shows an embodiment where the straight portion 26 of the joining surface 20 is parallel to the tip edge 16.

FIG. 4 further shows an embodiment where the straight section 26 of the replacement tip 30 is parallel to the tip edge 16

FIG. 5 shows an expanded view of an arc 24 formed on the joining surface 20. The arc 24 is shown interspersed between two straight sections and the arc 24 could have one end defining an end of the joining surface. In such an arrangement the arc 24 may either form an end point of the joining surface 20 at the tip edge 16 or, when configured towards the leading edge 14, at the leading edge 14. The angle θ subtended by the arc 24 is defined by the angle θ formed between radial lines, defining the arc's radius R, emanating from end points E1, E2 of the arc 24, that are perpendicular to tangent lines T1, T2 located at these endpoints E1, E2.

In an exemplary method, before damaged portions of a FIG. 1 airfoil tip 7 are removed, to prepare the airfoil 10 for heat-treatment to improve its weldability, any coatings can firstly be removed. The tip is removed for example by automated grinding wherein not only are damaged portions removed but also a specifically shaped joining surface 20 is formed. A replacement tip 30 is formed, for example by casting, to include a joining surface 20 mirroring that of the prepared airfoil 10 so as to be fittable on the joining surface 20 formed on the airfoil 10. The order of the steps of forming the joining surface 20 on the airfoil 10 and the forming of the replacement tip 30 can be reversed.

Once these steps have been completed, the replacement tip can be bonded to the airfoil 10 at the joining surface 20. During this process the replacement tip 30 can be clamped to the airfoil 10 so as to ensure correct alignment of the replacement tip 30 with the airfoil 10.

Although the disclosure has been herein shown and described in what is conceived to be the most practical exemplary embodiment, it is recognized that departures can be made within the scope of the disclosure, which is not to be limited to details described herein but is to be accorded the full scope of the appended claims so as to embrace any and all equivalent devices and apparatus.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMBERS

5 Blade
6 Platform
7 Tip
8 Ribs
10 Airfoil
12 Leading edge
14 Trailing edge
16 Tip edge
18 Tip plate
20 Join plain
22 Arc towards the leading edge
24 Arc towards the tip edge
26 Straight join plain section
30 Replacement tip
32 Blade platform
R Arc radius
RA Radial axis and radial direction
θ Angle subtended by arc
E1, E2 Arc end points
RD Replacement tip depth
RL Replacement tip length
T1, T2 Arc tangent

What is claimed is:

1. A gas turbine airfoil repair method for an airfoil which extends radially from a platform, wherein the airfoil includes: a tip edge at an airfoil end radially distant from said platform, a trailing edge, and a leading edge, the method comprising:
a) forming a joining surface extending from said leading edge to said tip edge, wherein said joining surface forms at least one arc;
b) forming a replacement tip fittable on the joining surface; and
c) bonding said replacement tip to said airfoil.

2. The method of claim 1 wherein said joining surface includes a straight section substantially parallel to said tip edge.

3. The method of claim 1 wherein said joining surface includes a straight section angled substantially between 0°-5° from said tip edge.

4. The method of claim 1 wherein said airfoil includes a tip plate, wherein said tip plate is wholly formed in said replacement tip.

5. The method of claim 1 wherein the joining surface has an arc towards the tip edge and an arc towards said leading edge.

6. A gas turbine airfoil repair method for an airfoil which extends radially from a platform, wherein the airfoil includes: a tip edge at an airfoil end radially distant from said platform, a trailing edge and a leading edge, the method comprising:
a) forming a joining surface extending from said leading edge to said tip edge, wherein said joining surface forms an arc towards the tip edge and is angled toward the tip edge;
b) forming a replacement tip fittable on said joining surface; and
c) bonding said replacement tip to said airfoil.

7. The method of claim 6 wherein said arc of step a) subtends an angle of substantially between 70°-100°.

8. The method of claim 6 wherein said arc of step a) substantially subtends an angle of between 80° to 90°.

9. The method of claim 6 wherein a radius of said arc of step a) is substantially between 10 and 20 mm.

10. The method of claim 6 wherein said joining surface includes a straight section substantially parallel to said tip edge of said platform.

11. The method of claim 6 wherein said joining surface includes a straight section angled between about 0°-5° from said tip edge of said platform.

12. The method of claim 6 wherein said airfoil includes:
a tip plate wherein said tip plate is wholly formed in said replacement tip.

13. A gas turbine airfoil repair method for an airfoil connected to a platform wherein the airfoil includes a tip region having a tip edge at an airfoil end distant from said platform, a trailing edge and a leading edge, the method comprising:
a) forming a joining surface extending from said leading edge to said tip edge wherein said joining surface forms an arc towards the leading edge;
b) forming a replacement tip fittable on said joining surface; and
c) bonding said replacement tip to said airfoil.

14. The method of claim 13 wherein at least one said arc towards the leading edge angles the joining surface towards said platform.

15. The method of claim 13 wherein said arc of step a) subtends an angle of between about 70°-100°.

16. The method of claim 13 wherein said arc of step a) subtends an angle of between about 80° to 90°.

17. The method of claim 13 wherein the radius of said arc of step a) is between about 10 and 20 mm.

18. The method of claim 13 wherein said joining surface includes:
a straight section substantially parallel to said tip edge of said platform.

19. The method of claim 13 wherein said joining surface includes:
a straight section angled between about 0°-5° from said tip edge of said platform.

20. The method of claim 13 wherein said airfoil includes:
a tip plate, wherein said tip plate is wholly formed in said replacement tip.

21. A gas turbine airfoil which extends radially from a platform, the airfoil comprising:
a tip edge at an airfoil end configured to be radially distant from the platform and to extend around the airfoil between a trailing edge of the airfoil and a leading edge of the airfoil;
a joining surface formed in the airfoil which extends from the leading edge to a portion of the tip edge located between the trailing edge and the leading edge, wherein the joining surface forms at least one arc; and
a replacement tip fitted and bonded to the joining surface.
